(19) United States
(12) Patent Application Publication
(10) Pub. No.: US 2024/0369222 A1
(43) Pub. Date: Nov. 7, 2024

(54) GAS SHUTOFF DEVICE, AND WIRELESS DEVICE FOR GAS SHUTOFF DEVICE

(71) Applicant: Panasonic Intellectual Property Management Co., Ltd., Osaka (JP)

(72) Inventors: Masaaki SAKATA, Nara (JP); Mitsuo Yokohata, Osaka (JP); Shota Teramoto, Nara (JP)

(21) Appl. No.: 18/778,300

(22) Filed: Jul. 19, 2024

Related U.S. Application Data
(62) Division of application No. 16/963,827, filed on Jul. 21, 2020.

(30) Foreign Application Priority Data
Mar. 13, 2018 (JP) 2018-044867
Mar. 13, 2018 (JP) 2018-044868

(51) Int. Cl. F23N 1/00; F23N 5/18; F23N 5/20; G01F 1/00; G01F 15/00; G01F 15/063; G08C 17/02

(52) U.S. Cl. CPC F23N 1/005; F23N 5/187; F23N 5/206; G01F 1/00; G01F 15/005; G01F 15/063; G08C 17/02; F23N 2223/38; F23N 2235/12; F23N 2237/04; F23N 2239/04

(57) ABSTRACT

A gas meter includes a flow rate measuring part configured to measure a flow rate of gas flowing through a flow passage, a shutoff valve configured to shut off the flow passage, a wireless communicator configured to periodically perform wireless communication externally, and a communication interval setting part configured to set a communication interval in the wireless communication. The communication interval setting part is configured to set the communication interval according to the flow rate of gas measured by flow rate measuring part.

### CROSS-REFERENCE TO RELATED APPLICATIONS

This application is a divisional of U.S. application Ser. No. 16/963,827 filed Jul. 21, 2020, which was filed as a U.S. national stage application of PCT International Application No. PCT/JP2019/008498 filed Mar. 5, 2019, which claims the benefit of foreign priority of Japanese Application No. 2018-044867 filed Mar. 13, 2018, and Japanese Application No. 2018-044868 filed Mar. 13, 2018, the contents all of which are incorporated herein by reference.

### TECHNICAL FIELD

The present invention relates to a gas shutoff device having a communication function, and a wireless device for gas shutoff device.

### BACKGROUND ART

An automatic wireless metering system has been put into practical use, which automatically performs metering of a metering value of a meter that measures an amount of usage of utilities such as gas, electric power, and water.

Among the above meters, meters such as gas and water meters are difficult to be supplied with power from a commercial power supply, and therefore, batteries are used as power supplies. Accordingly, power saving is required for the meter that uses the battery as the power supply. On the other hand, from the viewpoints of energy consumption visualization, energy management including energy monitoring, and added value, there are tendencies such that a metering frequency is increased in order to grasp finer usage charges and to grasp metering values in a shorter cycle, and new sensors are added in order to acquire various information from the meter and improve the value of the meter.

From these viewpoints, various methods have been studied to suppress a current consumption of the meter or a wireless device for the meter. Moreover, as a communication method, a method of communicating using a Low Power Wide Area (LPWA) communication module at all times or in a shorter communication interval has been proposed. However, a gas meter or a wireless device for the gas meter is intended to be used without battery replacement for 10 years, and accordingly, power saving is required. In addition, from the viewpoint of added value, current consumption suppression and responsiveness are also important factors. For example, intermittent driving is performed on a meter side and a synchronization signal is transmitted on a master unit side in a short cycle in order to achieve both the current consumption suppression and the responsiveness (for example, refer to Unexamined Japanese Patent Publication No. 2001-160990). A gas meter having a shutoff valve for shutting off a flow passage of gas can be restated as a gas shutoff device, and a wireless device for the meter used for the gas meter having the shutoff valve can be restated as a wireless device for a gas shutoff device.

### SUMMARY OF THE INVENTION

However, although the power saving can be realized at a certain level with the conventional method, because the power saving is related to a transmission time limit on the master unit side and a reception interval of the meter side or wireless device for meter, the current consumption cannot be suppressed more than a certain amount.

There is also a method of transmitting information to a master unit at the timing of the meter side or the wireless device for meter, and acquiring the information from the master unit after the transmission. With this method, the meter or the wireless device for meter can operate a communication portion in a sleep or low-consumption mode except for a timing of transmission, therefore, the power saving can be achieved.

When this method is used for power saving, the meter or the wireless device for meter generally transmits the information to the master unit in a very long cycle, and a response from the master unit is also received at the above timing. Therefore, a state of the meter is unknown for a long time, or even when data for changing a setting is received from the master unit, the setting of the change cannot be reflected for a long time.

A meter or a wireless device for meter according to the present invention, that is, a gas shutoff device or a wireless device for gas shutoff device, changes a communication interval according to a flow rate measured by a flow rate measuring part, to thereby enhance a responsiveness required according to the flow rate while a minimum necessary communication frequency is maintained, and accordingly, power saving can be achieved and also convenience can be maintained.

The gas shutoff device according to the present invention includes a flow rate measuring part that measures a flow rate of gas flowing through a flow passage, a shutoff valve that shuts off the flow passage, a wireless communicator that periodically performs wireless communication externally, and a communication interval setting part that sets a communication interval in the wireless communication. The communication interval setting part sets the communication interval according to the flow rate of gas measured by the flow rate measuring part.

With the configuration of changing the communication interval according to the flow rate measured by the flow rate measuring part, the responsiveness required according to the flow rate is enhanced while the minimum necessary communication frequency is maintained, and accordingly, the power saving can be achieved and also the convenience can be maintained.

Further, the wireless device for gas shutoff device of the present invention includes a meter communicator that communicates with a gas shutoff device having a flow rate measuring part that measures a flow rate of gas flowing through a flow passage and a shutoff valve that shuts off the flow passage, a wireless communicator that periodically performs wireless communication externally, and a communication interval setting part that sets a communication interval in the wireless communication. The communication interval setting part sets the communication interval according to the flow rate of gas obtained by the meter communicator.

With the configuration of changing the communication interval of the wireless device for gas shutoff device according to the flow rate measured on the side of the gas shutoff device, the responsiveness required according to the flow rate is enhanced while the minimum necessary communication frequency is maintained, and accordingly, the power saving can be achieved and also the convenience can be maintained.

### BRIEF DESCRIPTION OF DRAWINGS

FIG. 1 is a block diagram showing a gas shutoff device according to a first exemplary embodiment.

FIG. 2 is a diagram showing an example of a first communication interval setting of the gas shutoff device according to the first exemplary embodiment.

FIG. 3 is a diagram showing an example of a second communication interval setting of the gas shutoff device according to the first exemplary embodiment.

FIG. 4 is a diagram showing another example of the communication interval setting of the gas shutoff device according to the first exemplary embodiment.

FIG. 5 is a diagram showing another example of the communication interval setting of the gas shutoff device according to the first exemplary embodiment.

FIG. 6 is a block diagram showing a wireless device for gas shutoff device and a gas shutoff device according to a second exemplary embodiment.

### DESCRIPTION OF EMBODIMENTS

### First Exemplary Embodiment

An exemplary embodiment of a gas shutoff device according to the present invention is described below with reference to the accompanying drawings. In the exemplary embodiment described below, a gas meter is taken as an example of the gas shutoff device, and processing of the gas meter is described. In the drawings, the same constitutional elements are designated by the same reference numerals, and the description of the constitutional element already described is omitted. The present invention is not limited to the exemplary embodiment described below.

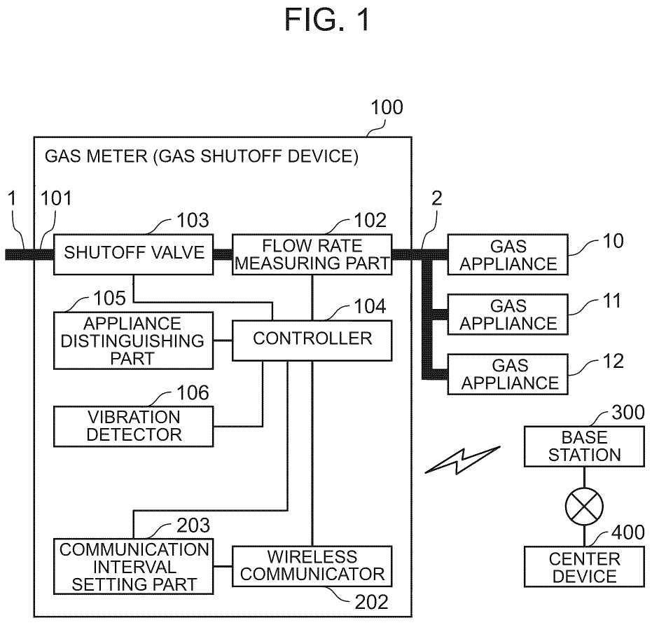

FIG. 1 is a block diagram of a gas meter being a gas shutoff device according to a first exemplary embodiment of the present invention.

In FIG. 1, gas meter 100 includes flow passage 101 through which gas flows, flow rate measuring part 102 that measures a flow rate of gas flowing through flow passage 101, and shutoff valve 103 that shuts off flow passage 101. In addition, gas meter 100 includes controller 104 that exchanges signals with constitutional elements inside gas meter 100 including shutoff valve 103, appliance distinguishing part 105 that determines a gas appliance connected to gas meter 100, and vibration detector 106 that detects vibration caused by an earthquake or the like. Gas meter 100 also includes wireless communicator 202 that communicates with base station 300 being an external device, and communication interval setting part 203 that controls a communication interval in wireless communicator 202. Further, gas meter 100 is connected to gas pipe 1, and gas appliances 10 to 12 are connected to gas meter 100 on a downstream side of gas meter 100 via gas pipes 2.

The constitutional elements and functions in a block are described below.

Flow rate measuring part 102 that measures the flow rate of gas flowing through flow passage 101 is constituted of an ultrasonic flow meter. Flow rate measuring part 102 constituted of the ultrasonic flow meter measures a flow rate of gas as a fluid flowing through flow passage 101 by emitting ultrasonic waves at a fixed time interval (for example, every 0.5 seconds or 2 seconds) to the gas. Here, a common type of gas can be used. In addition, flow rate measuring part 102 is not particularly limited in the configuration, and can be constituted of a circuit for calculating the flow rate by thermal fluctuation, a metering diaphragm in a case of measuring gas, or the like.

Shutoff valve 103 is constituted of an electromagnetic valve, a valve using a stepping motor, or the like, and the shutoff valve can be opened and closed according to an instruction from controller 104 described later. Shutoff valve 103 has functions such that when shutoff valve 103 is opened, the gas is supplied to gas appliances 10 to 12 connected downstream of gas meter 100, and when shutoff valve 103 is closed, the gas is stopped to be supplied.

Appliance distinguishing part 105 distinguishes a type of gas appliance started to be used (water heater, fan heater, stove, and so on), based on a flow rate value acquired by flow rate measuring part 102, and based on changing patterns of flow rate obtained when gas appliances 10 to 12 are started to operate.

Vibration detector 106 is constituted of a vibration sensor, an acceleration sensor, and the like, detects vibration such as an earthquake, and when the vibration more than or equal to a predetermined magnitude is detected, determines that the earthquake has occurred, and then outputs an earthquake occurrence signal, or outputs a vibration value corresponding to a magnitude of the vibration.

Controller 104 is mainly constituted of a microcomputer, a memory, a clock, a storage device, and the like (none of which are shown). Controller 104 is connected to flow rate measuring part 102, shutoff valve 103, appliance distinguishing part 105, vibration detector 106, and wireless communicator 202 described later to exchange signals. Then, controller 104 calculates and integrates the flow rate based on flow rate data measured by flow rate measuring part 102, determines whether or not an abnormality has occurred, shuts off flow passage 101 by shutoff valve 103, and the like. The abnormality leading to the shutoff of flow passage 101 by shutoff valve 103 is exemplified by an abnormality in which the flow rate of gas exceeds a preset maximum flow rate, an abnormality in which a gas usage time period exceeds a preset maximum usage time period, or an occurrence of earthquake or the like detected by vibration detector 106.

Further, controller 104 controls wireless communicator 202 based on a predetermined communication protocol, and wireless communicator 202 transmits a stored integrated value, an output result of vibration detector 106, a control result and a state of shutoff valve 103, and the like to base station 300 being the external device of gas meter 100.

Wireless communicator 202 is constituted of a transmission circuit, a reception circuit, a demodulation circuit, a modulation circuit, a voltage controlled oscillator circuit (VCO circuit), an antenna, and the like (none of which are shown), and according to a predetermined protocol, communicates with, that is, performs transmission and reception with base station 300 outside gas meter 100. Then, radio communicator 202 transmits the integrated value of an amount of gas usage obtained by controller 104, or transmits the detected abnormality to base station 300, or controls the gas meter based on an instruction from base station 300. Accordingly, flow passage 101 can be shut off by shutoff valve 103 of gas meter 100 according to an instruction from center device 400.

Communication interval setting part 203 has a function of controlling the communication interval in wireless communicator 202 based on information obtained from controller 104. Details are described later.

Base station 300 communicates with wireless communicator 202 of gas meter 100 via a not-shown communicator. Further, base station 300 communicates with center device 400 managed and operated by a gas company or the like via an internet line or the like. Additionally, a configuration of center device 400 also serving as base station 300 may be adopted.

With the above configuration, gas meter 100 and center device 400 can communicate with each other, and data such as the amount of gas usage obtained by gas meter 100 can be communicated to center device 400. Further, center device 400 can instruct gas meter 100 to shut off the gas by shutoff valve 103.

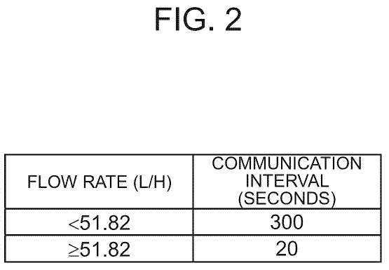

FIG. 2 shows an example of a first communication interval setting made by communication interval setting part 203 of gas meter 100 being the gas shutoff device. In the example of the first communication interval setting, when the flow rate of gas is less than a predetermined flow rate (51.82 L/H), the communication interval is set to 300 seconds, and when the flow rate of gas is more than or equal to the predetermined flow rate (51.82 L/H), the communication interval is set to 20 seconds. This predetermined flow rate (51.82 L/H) is a flow rate at which it can be determined that a gas appliance is being used, and therefore, this predetermined flow rate is a value from which it can be determined that the gas is not being used when the flow rate is smaller than this predetermined flow rate, and some kind of gas appliance is being used when the flow rate is more than or equal to the predetermined flow rate.

With the above communication interval setting, a responsiveness from center device 400 to gas meter 100 can be enhanced during use of the gas. Therefore, even in a case of remotely shutting off flow passage 101, as a service of a gas company, in response to contact from a user who is currently out and has forgotten to turn off the gas appliance, flow passage 101 can be quickly shut off and safety can be secured.

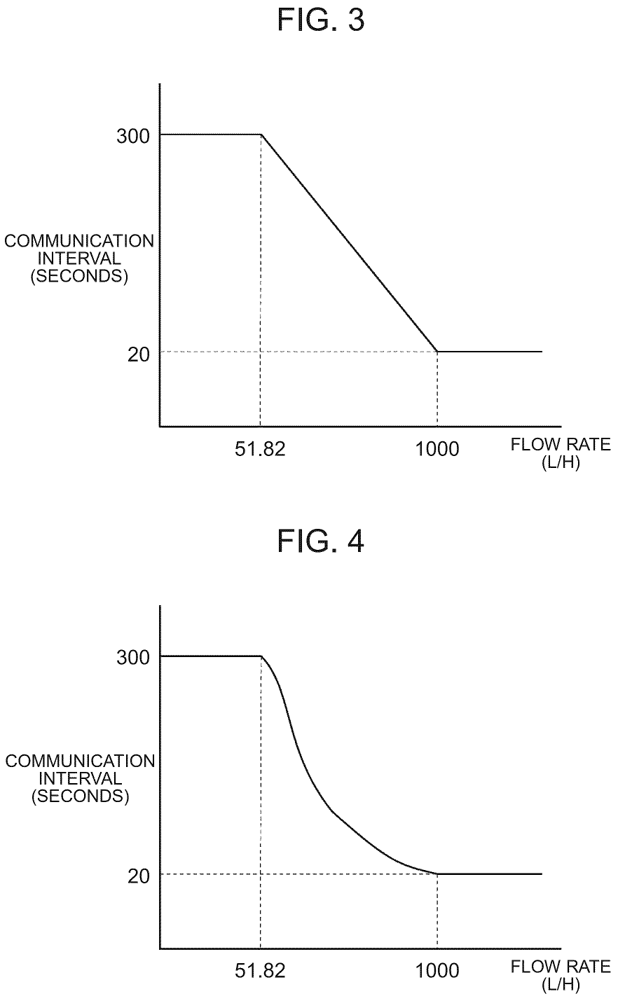

FIG. 3 shows an example of a second communication interval setting made by communication interval setting part 203 of gas meter 100 being the gas shutoff device. In the example of the second communication interval setting, the communication time interval is shortened from 300 seconds to 20 seconds according to an increase of flow rate, in a range of flow rate of gas within a predetermined flow rate (51.82 L/H to 1000 L/H).

According to the above communication interval setting, when an integrated value of the amount of gas usage is communicated from gas meter 100 to center device 400, an amount of change in the integrated value per hour can be reduced by increasing a communication frequency as the flow rate increases. Therefore, because center device 400 can finely grasp a gas usage status, the gas usage status can be acquired in real time and a demand analysis can be performed.

In the example of the communication interval setting shown in FIG. 3, the flow rate and the communication time interval are changed in proportion to each other. Alternatively, FIG. 4 shows another example of the communication interval setting made by communication interval setting part 203. As shown in FIG. 4, in the example of this communication interval setting, the transmission time is exponentially shortened as the flow rate increases. By the communication interval setting in this way, an accuracy required can be obtained according to the flow rate, and the communication interval setting can be arbitrarily set according to the accuracy required for the demand analysis.

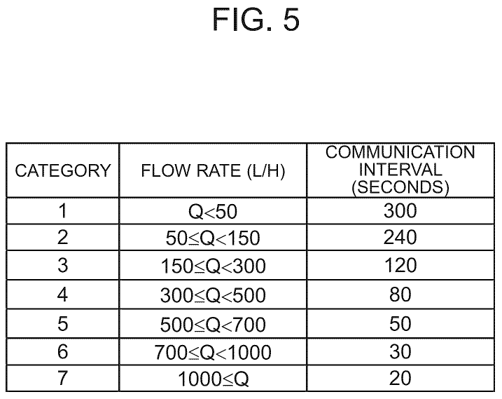

Further, FIG. 5 shows another example of the communication interval setting made by communication interval setting part 203. As shown in FIG. 5, in the example of this communication interval setting, the communication interval in wireless communicator 202 is set for each predetermined flow rate category, and the communication interval is set according to the flow rate category to which a flow rate Q measured by flow rate measuring part 102 belongs. With this configuration, the communication interval can be arbitrarily set without calculation according to a flow rate band.

As described above, according to gas meter 100 being the gas shutoff device according to the present exemplary embodiment, by changing the communication interval in wireless communicator 202 according to the flow rate measured on the meter side, the responsiveness required according to the flow rate is enhanced while the minimum necessary communication frequency is secured. Therefore, power saving can be achieved and also convenience can be maintained.

Additionally, based on the flow rate of gas measured by flow rate measuring part 102, after it is determined that the gas is started to be used, when a configuration is made in which the communication interval in wireless communicator 202 is set to a possible shortest time just for a predetermined time period, center device 400 can quickly respond to an abnormality that may occur when the gas appliance is started to be used.

Further, after shutoff valve 103 is closed by detecting an abnormality based on the flow rate of gas measured by flow rate measuring part 102 or occurrence of an earthquake by vibration detector 106, the communication interval in wireless communicator 202 is set to a possible shortest time just for a predetermined time period, and accordingly, center device 400 can quickly respond to the abnormality when the abnormality occurs.

The present invention is not limited to the above-described exemplary embodiment, and can be implemented in various modes without departing from the scope of the present invention. For example, in the present exemplary embodiment, the flow rate to determine the usage of gas appliance has been described as 51.82 L/H, however, when the gas appliance installed downstream the gas meter is known in advance, the flow rate to determine the usage of gas appliance can be set according to the minimum flow rate of the gas appliance. Further, the communication interval in wireless communicator 202 has been described as 300 seconds at maximum and 20 seconds at minimum, however, it is obvious that the communication interval can be arbitrarily set according to a battery capacity and the required responsiveness.

### Second Exemplary Embodiment

Hereinafter, a wireless device for gas shutoff device according to a second exemplary embodiment of the present invention is described with reference to the accompanying drawings. In the exemplary embodiment described below, as an example of the wireless device for gas shutoff device, a wireless slave unit that is connected by wire to a gas meter being a gas shutoff device is exemplified, and processing of the wireless slave unit is described. In the drawings, the same constitutional elements as those of the gas shutoff device according to the first exemplary embodiment are designated by the same reference numerals. The present invention is not limited to the exemplary embodiment described below.

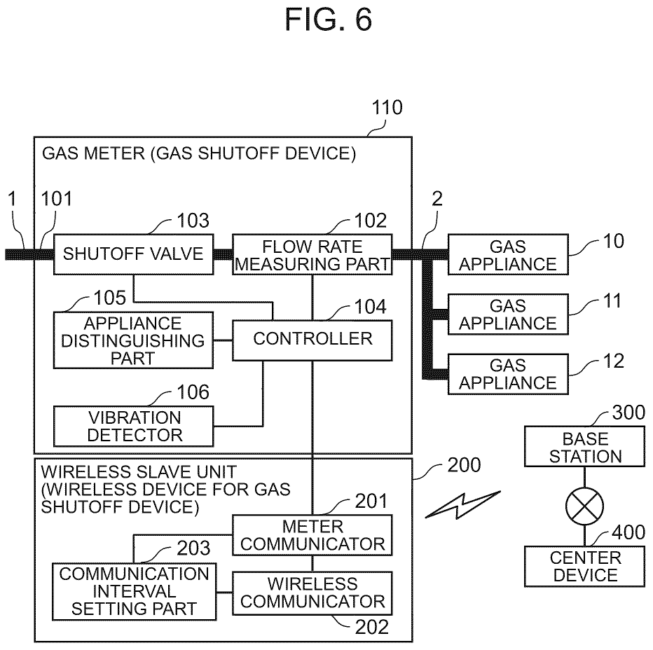

FIG. 6 is a block diagram of the wireless slave unit being the wireless device for gas shutoff device, and the gas meter being the gas shutoff device connected by wire to the wireless slave unit, according to the second exemplary embodiment of the present invention.

In FIG. 6, gas meter 110 includes flow passage 101 through which gas flows, flow rate measuring part 102 that measures a flow rate of gas flowing through flow passage 101, and shutoff valve 103 that shuts off flow passage 101. Further, gas meter 110 includes controller 104 that exchanges signals with constitutional elements inside gas meter 110 including shutoff valve 103, appliance distinguishing part 105 that determines a gas appliance connected to gas meter 110, and vibration detector 106 that detects vibration caused by an earthquake or the like. Further, gas meter 110 is connected to gas pipe 1, and gas appliances 10 to 12 are connected on a downstream side of gas meter 110 via gas pipe 2.

Wireless slave unit 200 being the wireless device for gas shutoff device, includes meter communicator 201 connected to controller 104 of gas meter 110, wireless communicator 202 and communication interval setting part 203 respectively connected to meter communicator 201.

The constitutional elements and functions in a block are described below.

Flow rate measuring part 102 that measures the flow rate of gas flowing through flow passage 101 is constituted of an ultrasonic flow meter. Flow rate measuring part 102 constituted of the ultrasonic flow meter measures a flow rate of gas as a fluid flowing through flow passage 101 by emitting ultrasonic waves at a fixed time interval (for example, every 0.5 seconds or 2 seconds) to the gas. Here, a common type of gas can be used. In addition, a configuration of flow rate measuring part 102 is not particularly limited, and flow rate measuring part 102 can be constituted of a circuit for calculating the flow rate by thermal fluctuation, or can be constituted of a metering diaphragm in a case of measuring gas.

Shutoff valve 103 is constituted of an electromagnetic valve, a valve using a stepping motor, or the like, and the shutoff valve can be opened and closed according to an instruction from controller 104 described later. Shutoff valve 103 has functions such that when shutoff valve 103 is opened, the gas is supplied to gas appliances 10 to 12 connected downstream of gas meter 100, and when shutoff valve 103 is closed, the gas is stopped to be supplied.

Appliance distinguishing part 105 distinguishes a type of gas appliance started to be used (water heater, fan heater, stove, and so on), based on a flow rate value acquired by flow rate measuring part 102, and based on changing patterns of flow rate obtained when gas appliances 10 to 12 are started to operate.

Vibration detector 106 is constituted of a vibration sensor, an acceleration sensor, and the like, detects vibration such as an earthquake, and when the vibration more than or equal to a predetermined magnitude is detected, determines that the earthquake has occurred, and then outputs an earthquake occurrence signal, or outputs a vibration value corresponding to a magnitude of the vibration.

Controller 104 is mainly constituted of a microcomputer, a memory, a clock, a storage device, and the like (none of which are shown). Controller 104 is connected to flow rate measuring part 102, shutoff valve 103, appliance distinguishing part 105, and vibration detector 106 to exchange signals, and at the same time, connected to meter communicator 201 described later via a communication interface (not shown) to exchange signals. Then, controller 104 calculates and integrates the flow rate based on flow rate data measured by flow rate measuring part 102, determines whether or not an abnormality has occurred, and shuts off flow passage 101 using shutoff valve 103. The abnormality leading to the shutoff of flow passage 101 by shutoff valve 103 is exemplified by an abnormality in which the flow rate of gas exceeds a preset maximum flow rate, an abnormality in which a gas usage time period exceeds a preset maximum usage time period, or the occurrence of earthquake or the like detected by vibration detector 106.

Further, controller 104 has a function to communicate with meter communicator 201 of wireless slave unit 200 being the wireless device for gas shutoff device based on a predetermined communication protocol.

Meter communicator 201 communicates with controller 104, and receives, from controller 104, an integrated value stored in controller 104, an output result of vibration detector 106, a control result and a state of shutoff valve 103, and the like. Alternatively, meter communicator 201 transmits control data and the like received from center device 400 described later to controller 104.

Wireless communicator 202 is constituted of a transmission circuit, a reception circuit, a demodulation circuit, a modulation circuit, a VCO circuit, an antenna, and the like (none of which are shown), and according to a predetermined protocol, communicates with, that is, performs transmission and reception with base station 300 outside gas meter 110. Then, wireless communicator 202 transmits the integrated value of an amount of gas usage obtained via meter communicator 201 or the detected abnormality to base station 300, or transmits control data instructed from base station 300 to gas meter 110 via meter communicator 201. Accordingly, flow passage 101 can be shut off by shutoff valve 103 of gas meter 110 according to an instruction from center device 400.

Communication interval setting part 203 has a function of controlling a communication interval in wireless communicator 202 based on information obtained via meter communicator 201. Details are described later.

Base station 300 communicates with wireless communicator 202 of wireless slave unit 200 being the wireless device for gas shutoff device via the not-shown communicator. Further, base station 300 communicates with center device 400 managed and operated by a gas company or the like via an internet line or the like. Additionally, a configuration of center device 400 also serving as base station 300 may be adopted.

With the above configuration, gas meter 110 can communicate with center device 400 via wireless slave unit 200, and data such as an amount of gas usage obtained by gas meter 110 can be communicated to center device 400. Further, center device 400 can instruct gas meter 110 to shut off the gas by shutoff valve 103.

Next, an example of a communication interval setting between wireless communicator 202 provided in wireless slave unit 200 being the wireless device for gas shutoff device according to the present exemplary embodiment and base station 300 is described. Note that the example of the communication interval setting in the present exemplary embodiment is similar to the example of the communication interval setting in the first exemplary embodiment, and is described with reference to FIG. 2 to FIG. 5.

FIG. 2 shows a first example of setting time made by communication interval setting part 203 of wireless slave unit 200 being the wireless device for gas shutoff device according to the present exemplary embodiment. In the example of the first communication interval setting, when the flow rate of gas is less than a predetermined flow rate (51.82 L/H), the communication interval is set to 300 seconds, and when the flow rate of gas is more than or equal to the predetermined flow rate (51.82 L/H), the communication interval is set to 20 seconds. This predetermined flow rate (51.82 L/H) is a flow rate at which it can be determined that a gas appliance is being used, and therefore, this predetermined flow rate is a value from which it can be determined that the gas is not being used when the flow rate is smaller than this predetermined flow rate, and some kind of gas appliance is being used when the flow rate is more than or equal to the predetermined flow rate.

With the above communication interval setting, a responsiveness from center device 400 to gas meter 110 via wireless slave unit 200 can be enhanced during use of the gas. Therefore, even in a case of remotely shutting off flow passage 101, as a service of a gas company, in response to contact from a user who is currently out and has forgotten to turn off the gas appliance, flow passage 101 can be quickly shut off and safety can be secured.

FIG. 3 shows an example of a second communication interval setting made by communication interval setting part 203 of wireless slave unit 200 being the wireless device for gas shutoff device. In the example of the second communication interval setting, the communication time interval is shortened from 300 seconds to 20 seconds according to an increase of flow rate, in a range of flow rate of gas within a predetermined flow rate (51.82 L/H to 1000 L/H).

According to the above communication interval setting, when the integrated value of the amount of gas usage is communicated from wireless slave unit 200 to center device 400, an amount of change in the integrated value per hour can be reduced by increasing a communication frequency as the flow rate increases. Therefore, because center device 400 can finely grasp a gas usage status, the gas usage status can be acquired in real time and a demand analysis can be performed.

In the example of the communication interval setting shown in FIG. 3, the flow rate and the communication time interval are changed in proportion to each other. Alternatively, FIG. 4 shows another example of the communication interval setting made by communication interval setting part 203. As shown in FIG. 4, in the example of this communication interval setting, the transmission time is exponentially shortened as the flow rate increases. By the communication interval setting in this way, an accuracy required can be obtained according to the flow rate, and the communication interval setting can be arbitrarily set according to the accuracy required for the demand analysis.

Further, FIG. 5 shows another example of the communication interval setting made by communication interval setting part 203. As shown in FIG. 5, in the example of this communication interval setting, the communication interval in wireless communicator 202 is set for each predetermined flow rate category, and the communication interval is set according to the flow rate category to which a flow rate Q measured by flow rate measuring part 102 belongs. With this configuration, the communication interval can be arbitrarily set without calculation according to a flow rate band.

As described above, according to wireless slave unit 200 being the wireless device for gas shutoff device according to the present exemplary embodiment, by changing the communication interval in wireless communicator 202 of wireless slave unit 200 according to the flow rate measured in gas meter 110, the responsiveness required according to the flow rate is enhanced while the minimum necessary communication frequency is secured. Therefore, power saving can be achieved and also convenience can be maintained.

Additionally, based on the flow rate of gas measured by flow rate measuring part 102, after it is determined that the gas is started to be used, when a configuration is made in which the communication interval in wireless communicator 202 is set to a possible shortest time just for a predetermined time period, center device 400 can quickly respond to an abnormality that may occur when the gas appliance is started to be used.

Further, after shutoff valve 103 is closed by detecting an abnormality based on the flow rate of gas measured by flow rate measuring part 102 or occurrence of an earthquake by vibration detector 106, the communication interval in wireless communicator 202 is set to a possible shortest time just for a predetermined time period, and accordingly, center device 400 can quickly respond to the abnormality when the abnormality occurs.

The present invention is not limited to the above-described exemplary embodiment, and can be implemented in various modes without departing from the scope of the present invention. For example, in the present exemplary embodiment, the flow rate to determine the usage of the gas appliance has been described as 51.82 L/H, however, when the gas appliance installed downstream the gas meter is known in advance, the flow rate to determine the usage of gas appliance can be set according to the minimum flow rate of the gas appliance. Further, the communication interval in wireless communicator 202 has been described as 300 seconds at maximum and 20 seconds at minimum, however, it is obvious that the communication interval can be arbitrarily set according to a battery capacity and the required responsiveness.

As described above, a gas shutoff device according to a first aspect of the present invention includes a flow rate measuring part that measures a flow rate of gas flowing through a flow passage, a shutoff valve that shuts off the flow passage, a wireless communicator that periodically performs wireless communication externally, and a communication interval setting part that sets a communication interval in the wireless communication. The communication interval setting part sets the communication interval according to the flow rate of gas measured by the flow rate measuring part. By changing the communication interval according to the flow rate measured by the flow rate measuring part, responsiveness required according to the flow rate is enhanced while a minimum necessary communication frequency is maintained, and accordingly, power saving can be achieved and also convenience can be maintained.

The gas shutoff device according to a second aspect of the present invention may be configured such that, according to the first aspect of the present invention, when the communication interval setting part determines based on the flow rate of gas measured by the flow rate measuring part that gas is not being used, the communication interval setting part sets the communication interval to a possible longest time that is preset, and when the communication interval setting part determines based on the flow rate of gas measured by the flow rate measuring part that the gas is being used, the communication interval setting part sets the communication interval to be shorter than the possible longest time.

The gas shutoff device according to a third aspect of the present invention may be configured such that, according to the first aspect of the present invention, the gas shutoff device has the flow rate of gas measured by the flow rate measuring part are categorized into a plurality of gas flow rate categories each having a predetermined flow rate band, and the communication interval setting part sets the communication interval according to the gas flow rate category to which the flow rate of gas measured by the flow rate measuring part belongs.

The gas shutoff device according to a fourth aspect of the present invention may be configured such that, according to the second aspect of the present invention, the gas shutoff device has the flow rate of gas measured by the flow rate measuring part are categorized into a plurality of gas flow rate categories each having a predetermined flow rate band, and the communication interval setting part sets the communication interval according to the gas flow rate category to which the flow rate of gas measured by the flow rate measuring part belongs.

The gas shutoff device according to a fifth aspect of the present invention may be configured such that, according to any one of the first to fourth aspects of the present invention, when the communication interval setting part determines based on the flow rate of gas measured by the flow rate measuring part that the gas is started to be used, the communication interval setting part sets the communication interval to a possible shortest time for a predetermined time period.

The gas shutoff device according to a sixth aspect of the present invention may be configured such that, according to any one of the first to fourth aspects of the present invention, the communication interval setting part sets the communication interval after the shutoff valve is shut off to a possible shortest time that is preset, for a predetermined time period. The gas shutoff device according to a seventh aspect of the present invention may be configured such that, according to the fifth aspect of the present invention, the communication interval setting part sets the communication interval after the shutoff valve is shut off to a possible shortest time that is preset, for a predetermined time period.

A wireless device for gas shutoff device according to an eighth aspect of the present invention includes a meter communicator that communicates with a gas shutoff device having a flow rate measuring part that measures a flow rate of gas flowing through a flow passage and a shutoff valve that shuts off the flow passage, a wireless communicator that periodically performs wireless communication externally, and a communication interval setting part that sets a communication interval in the wireless communication. The communication interval setting part sets the communication interval according to the flow rate of gas obtained by the meter communicator. By changing the communication interval of the wireless device for meter according to the flow rate measured on a meter side, responsiveness required according to the flow rate is enhanced while a minimum necessary communication frequency is maintained, and accordingly, power saving can be achieved and also convenience can be maintained.

The wireless device for gas shutoff device according to a ninth aspect of the present invention may be configured such that, according to the eighth aspect of the present invention, when the communication interval setting part determines based on the flow rate of gas obtained by the meter communicator that gas is not being used, the communication interval setting part sets the communication interval to a possible longest time that is preset, and when the communication interval setting part determines based on the flow rate of gas measured by the flow rate measuring part that the gas is being used, the communication interval setting part sets the communication interval to be shorter than the possible longest time.

The wireless device for gas shutoff device according to a tenth aspect of the present invention may be configured such that, according to the eight aspect of the present invention, the gas shutoff device has the flow rate of gas measured by the flow rate measuring part are categorized into a plurality of gas flow rate categories each having predetermined flow rate band, and the communication interval setting part sets the communication interval according to the gas flow rate category obtained by the meter communicator.

The wireless device for gas shutoff device according to an eleventh aspect of the present invention may be configured such that, according to the ninth aspect of the present invention, the gas shutoff device has the flow rate of gas measured by the flow rate measuring part are categorized into a plurality of gas flow rate categories each having a predetermined flow rate band, and the communication interval setting part sets the communication interval according to the gas flow rate category obtained by the meter communicator.

The wireless device for gas shutoff device according to a twelfth aspect of the present invention may be configured such that, according to any one of the eighth to eleventh aspects of the present invention, when the communication interval setting part determines based on the flow rate measured by the flow rate measuring part that the gas is started to be used, the communication interval setting part sets the communication interval to a possible shortest time for a predetermined time period.

The wireless device for gas shutoff device according to a thirteenth aspect of the present invention may be configured such that, according to any one of the eighth to eleventh aspects of the present invention, the communication interval setting part sets the communication interval after the shutoff valve is shut off to a possible shortest time that is preset, for a predetermined time period.

The wireless device for gas shutoff device according to a fourteenth aspect of the present invention may be configured such that, according to the twelfth aspect of the present invention, the communication interval setting part sets the communication interval after the shutoff valve is shut off to a possible shortest time that is preset, for a predetermined time period.

### INDUSTRIAL APPLICABILITY

As described above, the gas shutoff device or the wireless device for gas shutoff device according to the present invention can achieve power saving and also secure responsiveness by setting the communication interval according to the flow rate, and accordingly, can also be applied to water meters and the like powered by batteries.

### REFERENCE MARKS IN THE DRAWINGS

100, 110 gas meter (gas shutoff device)
101 flow passage
102 flow rate measuring part
103 shutoff valve
104 controller
105 appliance distinguishing part
106 vibration detector
200 wireless slave unit (wireless device for gas shutoff device)
201 meter communicator
202 wireless communicator
203 communication interval setting part
300 base station
400 center device

1. A gas shutoff device comprising:
a flow rate measuring part that measures a flow rate of gas flowing through a flow passage;
a shutoff valve that shuts off the flow passage;
a wireless communicator that periodically performs wireless communication externally; and
a communication interval setting part that sets a communication interval in the wireless communication,
wherein the communication interval setting part sets the communication interval according to the flow rate of gas measured by the flow rate measuring part.

2. The gas shutoff device according to claim 1,
wherein, when the communication interval setting part determines based on the flow rate of gas measured by the flow rate measuring part that gas is not being used, the communication interval setting part sets the communication interval to a possible longest time that is preset, and when the communication interval setting part determines based on the flow rate of gas measured by the flow rate measuring part that the gas is being used, the communication interval setting part sets the communication interval to be shorter than the possible longest time.

3. The gas shutoff device according to claim 1,
wherein the flow rates of gas measured by the flow rate measuring part are categorized into a plurality of gas flow rate categories each having a predetermined flow rate band, and
the communication interval setting part sets the communication interval according to one of the gas flow rate categories to which the flow rate of gas measured by the flow rate measuring part belongs.

4. The gas shutoff device according to claim 2,
wherein the flow rates of gas measured by the flow rate measuring part are categorized into a plurality of gas flow rate categories each having a predetermined flow rate band, and
the communication interval setting part sets the communication interval according to one of the gas flow rate categories to which the flow rate of gas measured by the flow rate measuring part belongs.

5. The gas shutoff device according to claim 1,
wherein, when the communication interval setting part determines based on the flow rate of gas measured by the flow rate measuring part that the gas is started to be used, the communication interval setting part sets the communication interval to a possible shortest time for a predetermined time period.

6. The gas shutoff device according to claim 1,
wherein the communication interval setting part sets the communication interval after the shutoff valve is shut off to a possible shortest time that is preset, for a predetermined time period.

7. The gas shutoff device according to claim 5,
wherein the communication interval setting part sets the communication interval after the shutoff valve is shut off to a possible shortest time that is preset, for a predetermined time period.

8. The gas shutoff device according to claim 1, further comprising a vibration detector configured to:
detect vibration; and
when the vibration is more than or equal to a predetermined magnitude, either:
(i) determine that an earthquake has occurred, and then output an earthquake occurrence signal; or
(ii) output a vibration value corresponding to a magnitude of the vibration.
